(19) United States
(12) Patent Application Publication
(10) Pub. No.: US 2006/0130110 A1
(43) Pub. Date: Jun. 15, 2006

(54) Apparatus for receiving MPEG-2 A/V data using cable modem

(76) Inventors: Yong-Seong Cho, Jeollabuk-do (KR); Woongshik You, Daejon (KR); O-Hyung Kwon, Daejon (KR); Soo-In Lee, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/212,153

(22) Filed: Aug. 25, 2005

(30) Foreign Application Priority Data
Dec. 13, 2004 (KR) 10-2004-0105092
May 10, 2005 (KR) 10-2005-0038704

(51) Int. Cl. H04N 7/173; H04N 7/16

(52) U.S. Cl. 725/111; 725/116; 725/117; 725/147

(57) ABSTRACT

An apparatus for receiving MPEG-2 A/V data by using a cable MODE is disclosed. The apparatus includes: a cable MODEM for separating broadcasting data and broadcasting supplementary data by demodulating an input signal; and a multiplexer for multiplexing the separated broadcasting data from the cable MODEM with broadcasting data inputted from other input source, and outputting the multiplexed broadcasting data to an external cable card.

### FIELD OF THE INVENTION

The present invention relates to an apparatus for receiving MPEG-2 audio/video (A/V) data by using a cable MODEM in a digital cable broadcasting system; and, more particularly, to a MPEG-2 A/V data receiving apparatus using a cable MODEM for processing A/V data transmitted through a cable MODEM according to a conditional access by using a cable card and providing the processed A/V data to a subscriber in a set-top box of a digital cable broadcasting system.

### Description of Related Arts

FIG. 1 is a block diagram illustrating a digital cable broadcasting system in accordance with a prior art.

As shown in FIG. 1, the digital cable broadcasting system includes a digital cable head end 100 that is a transmitting system and a subscriber terminal 200 connected to the digital cable head end 100 through a hybrid fiber coaxial (HFC) network 10.

The digital cable head end 100 includes an in-band network processing unit 110 and an output-of-band network processing unit 120.

The in-band network processing unit 110 transmits encoding motion picture experts group-2 (MPEG-2) audio/video (A/V) data based on a quadrature amplitude modulation (QAM) scheme through a digital video broadcasting-asynchronous serial interface (DVB-ASI). In order to transmit the data, the in-band network processing unit 110 includes: a MPEG-2 A/V unit 111 as an encoding unit for encoding MPEG-2 A/V data and a quadrature amplitude (QAM) modulator 112.

The output-of-band network processing unit 120 transmits supplementary data related to broadcasting based on a digital video subcommittee (DVS)-167 (ATM) or DVS-178(MPEG-2 TS) by including an application server 121 providing a conditional-receiving and an electronic program guide (EPG) service. Or, the output-of band processing unit 120 transmits supplementary data related to broadcasting and Internet protocol (IP) data based on a data over cable service interface specifications (DOCSIS) set-top gateway (DSG).

The out-of-band network processing unit 120 includes an out-of-band (OOB) modulator/demodulator (MODEM) 122 and a set-top controller 123 for transmitting the supplementary data related to broadcasting based on DVS-167 (ATM) or DVS-18 (MPEG-2 TS), where ATM denotes an asynchronous transfer mode and TS denote a transport stream. The out-of-band network processing unit 120 also includes a cable MODEM termination system (CMTS) 142 and a management system 125 for transmitting the supplementary data related to broadcasting and the IP data based on DOCSIS set-top gateway.

The subscriber terminal 200 includes a set-top box 230 and a cable card 250. The subscriber terminal 200 is connected to a television set (TV) or connected to a personal computer (PC) through a cable MODEM 240. The subscriber terminal 200 may be commonly connected to TV and PC through a cable MODEM built-in set-top box 210 and the cable card 250.

The subscriber terminal 200 receives signals transmitted from the digital cable head end 100 through the HFC network 10. That is, the set-top box 230 or the cable MODEM built-in set-top box 210 receives A/V data and supplementary data related to broadcasting, and outputs the A/V data and the supplementary data to a display unit such as TV after authenticating a subscriber's authority and processing the A/V data and the supplementary data according to a conditional access. Also, the cable MODEM built-in set-top box 210 or the cable MODEM 240 receives data related to Internet protocol (IP), and outputs the IP data to a computing system, such as a personal computer (PC).

FIG. 2 is a detailed diagram showing a open-cable based cable modem built-in set-top box and a cable card in accordance with a prior art.

In the OpenCable standard, a cable card is defined by separating a conditional access system from a conventional cable set-top box as an independent module, and a standard interface between a set-top box and the cable card is defined. Therefore, a set-top box may be manufactured by anyone who follows the interface standard of the OpenCable standard.

Accordingly, a use can receives a cable broadcasting service from a cable service operator (SO) according to a conditional access contract by directly purchasing an OpenCable standard based set-top box as like as buying a general electric household appliance and using a cable card provided from the cable service operator with the purchased set-top box.

As shown in FIG. 2, the OpenCable based cable MODEM built-in set-top box 210 includes a tuner 211, a QAM demodulator 212, an OOB transmitter/receiver 213, a cable MODEM 214, a de-multiplexer 215, a MPEG-2 A/V decoder 216, and a set-top box CPU 217. The cable card 250 includes an OOB processor 251, a conditional access (CA) processor 252 and a cable card CPU 253.

The tuner 211 and the QAM demodulator 212 tunes and demodulates MPEG-2 A/V TS transmitted through an In-band network, and the QAM demodulator 212 outputs the demodulated MPEG-2 A/V TS to the CA processor 252 through an In-band channel. Also, the tuner 211 tunes and outputs data related to a program guide and a conditional access transmitted through an out-of-band network to the OOB processor 251 of the cable card 250 through an out-of-band channel based on an out-of-band transmitting scheme. Otherwise, the tuner 211 tunes and outputs the data related to the program guide and the conditional access to the cable card CPU 253 through the set-top box CPU 217 and a CPU interface channel. The CPU interface channel includes a data channel and an extended channel, logically.

The OpenCable standard defines an In-band channel, an out-of-band channel and a CPU interface channel (Data channel, Extended channel) as a standard interface between a set-top box and a cable card. According to the OpenCable standard, the MPEG-2 A/V data is transmitted through the In-band channel, broadcasting receiving and supplementary data are transmitted through the out-of-band channel, and the data between the set-top box and the cable card is transmitted through the data channel that is a logical channel of the CPU interface channel.

Broadcasting signal inputted to the cable card, i.e., MPEG-2 A/V TS, is processed according to the conditional access, and is outputted to a display device of a subscriber such as TV through the de-multiplexer 205 and the MPEG-2 A/V decoder 206 in the set-top box.

Meanwhile, an Ethernet interface is recently introduced to a digital cable head end transmitting/receiving system for providing a smooth link between elements, managing and sharing resources within a system, and increasing extendibility.

Also, the In-band network transmitting the MPEG-2 A/V is developed from a single-channel broadcasting using a conventional QAM scheme to a multi-channel broadcasting using a plurality of QAM modulators for providing improved supplementary services to support a picture-in-picture (PIP) and a digital video recorder (DVR).

In case of the out-of-band network, a DOCSIS based cable MODEM transmitting scheme is selected to support high transmission rate. Conventionally, an OOB transmitting scheme based on DVS-167 or DVS-178 was selected for the out-of-band network. The DOCSIS based cable MODEM transmitting scheme supports high transmission rate of 27 Mbps or 38 Mbps and the OOB transmitting scheme based on DVS-167 or DVS-178 supports comparatively low data transmission rate of maximum 3 Mbps.

Furthermore, the DOCSIS based transmitting scheme can simultaneously transmit a supplementary data related to broadcasting and an IP service. That is, the DOCSIS based transmitting scheme is advantageous scheme to provide advanced supplementary services such as VOIP and VOD. Accordingly, both of A/V data transmitted as MPEG-2 TS and general IP data can be simultaneously transmitted by using a same head-end network infra. Therefore, the DOCSIS based out-of-band network transmitting system will be used in a next generation digital cable head end transmitting/receiving system to simultaneously provide not only an IP data service and a supplementary service such as VoIP, VOD, but also MPEG-2 TS A/V broadcasting data transmitted based on a conventional QAM scheme by using the DOCSIS based cable MODEM.

Meanwhile, a transmitting/receiving system using a DOCSIS based out-of-band network transmits broadcasting receiving and supplementary information, i.e., a conditional access information or an electronic program guide (EPG) information, through the extended channel of the CPU interface channel according to DOCSIS Set-Top Gateway (DSG) standard which is a transmission standard for transmitting/receiving data related to broadcasting through a cable MODEM.

In order to transmit MPEG-2 A/V TS through a cable MODEM by applying the DSG to the above described conventional OpenCable based set-top box, MPEG-2 A/V TS transmitted through a cable MODEM must be transmitted to the cable card through the extended channel to process the MPEG-2 A/V TS for the conditional access. That is, the MPEG-2 A/V TS is transmitted to the cable card through the extended channel guaranteeing a transmission rate of only 7Mbps, and the processed MPEG-2 A/V TS is transmitted back to the set-top box from the cable card through the extended channel after processing the MPEG-2 A/V TS for the conditional access.

If MPEG-2 A/V TS transmitted from DOCSIS based cable MODEM providing a transmission rate of maximum 27 Mbps or 38 Mbps is transmitted through the extended channel guaranteeing a transmission rate of 7 Mbps, significant amount of data would be lost and long delay would be generated. Therefore, it is impossible to provide a service for the condition access.

### SUMMARY OF THE INVENTION

It is, therefore, an object of the present invention to provide an apparatus for receiving MPEG-2 A/V data using a cable MODEM for processing MPEG-2 A/V data transmitted through a cable MODEM according to a conditional access while maintaining comparability to interface specifications defined in an OpenCable standard by multiplexing the MPEG-2 A/V data with data received through a QAM modulator and inputting/outputting the multiplexed data through an In-band channel.

In accordance with an aspect of the present invention, there is provided an apparatus for receiving broadcasting data using a cable MODEM in a digital cable broadcasting system, the apparatus including: a cable MODEM for separating broadcasting data and broadcasting supplementary data by demodulating an input signal; and a multiplexer for multiplexing the separated broadcasting data from the cable MODEM with broadcasting data inputted from other input source, and outputting the multiplexed broadcasting data to an external cable card.

In accordance with another aspect of the present invention, there is provided a cable MODEM in a digital cable broadcasting receiving system for processing broadcasting data received through a cable MODEM according to a conditional access in a cable card, the cable MODEM including: a demodulating unit for demodulating an inputted signal; and a data separating unit for receiving the demodulated signal from the demodulating unit and separating broadcasting data and broadcasting supplementary data from the demodulated signal.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a block diagram illustrating a digital cable broadcasting system in accordance with a prior art;

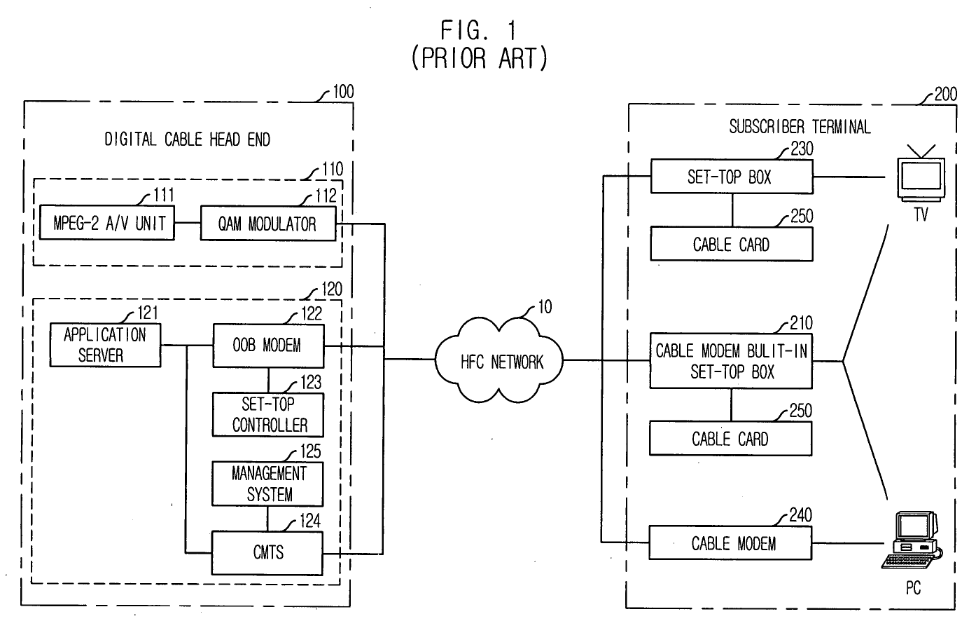

FIG. 2 is a detailed diagram showing a open-cable based cable modem built-in set-top bock and a cable card in accordance with a prior art;

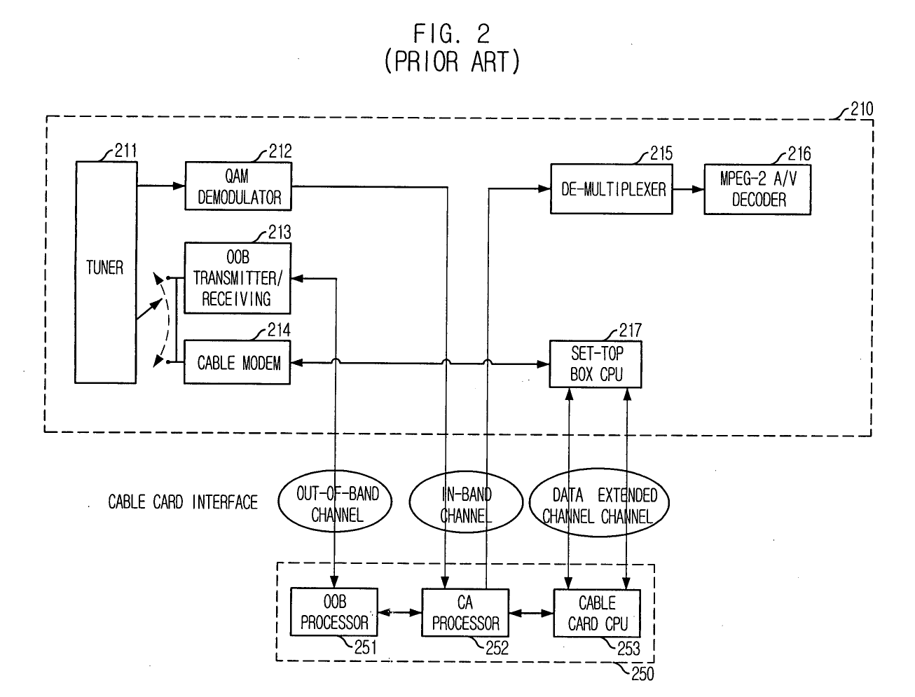

FIG. 3 is a block diagram depicting an apparatus for receiving MPEG-2 A/V data by using a cable modem in accordance with a preferred embodiment of the present invention;

FIG. 4 is a detailed diagram illustrating a cable modem in accordance with a preferred embodiment of the present invention; and

FIG. 5 is a flowchart of a method for processing MPEG-2 TS in a cable modem in accordance with a preferred embodiment of the present invention.

### DETAILED DESCRIPTION OF THE INVENTION

Hereinafter, a system and a method for providing an anti-virus program by using a wireless communication terminal in accordance with a preferred embodiment of the present invention will be described in more detail with reference to the accompanying drawings.

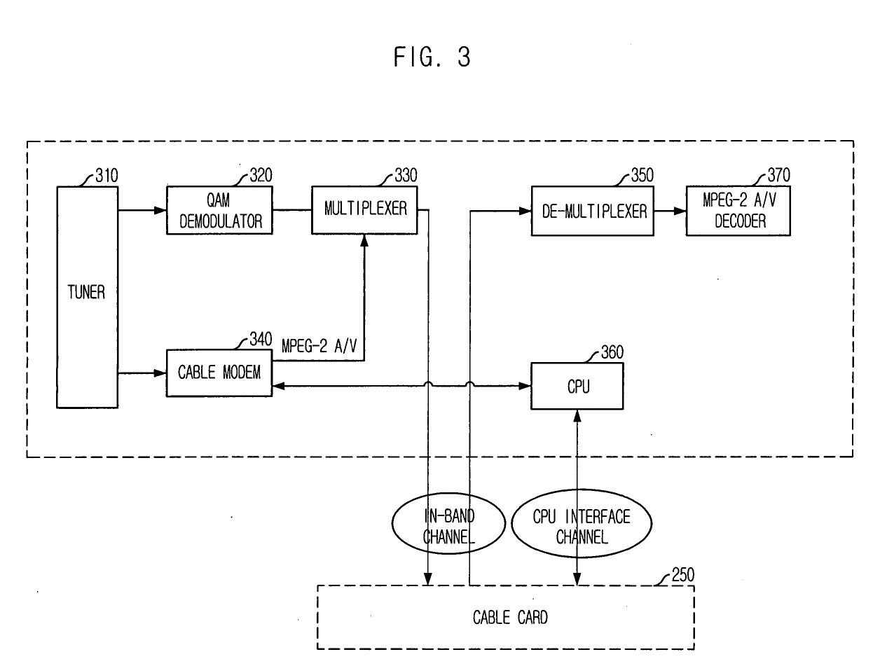

FIG. 3 is a block diagram depicting an apparatus for receiving MPEG-2 A/V data by using a cable modem in accordance with a preferred embodiment of the present invention.

As shown in FIG. 3, the apparatus for receiving MPEG-2 A/V data using a cable MODEM according to the present embodiment includes a tuner 310, a QAM demodulator 320, a multiplexer 330, a cable MODEM 340, a de-multiplexer 350, a MPEG-2 A/V decoder 370 and a CPU 360. Hereinafter, function of each element will be explained.

The tuner 310 receives a radio frequency (RF) signal transmitted from an external digital cable head end, and tunes data transmitted through an In-band network and data transmitted through an Out-of-band network. After tuning, the tuner 310 separates the data transmitted through an In-band network and the data transmitted through the Out-of-band network, and output the data transmitted through the In-band network to the QAM demodulator 320 and the data transmitted through the Out-of-band network to the cable MODEM 340.

The QAM demodulator 320 receives the data transmitted through the In-band network from the tuner 310. After receiving, the QAM demodulator 320 demodulates the received data, which was modulated based on a quadrature amplitude modulation (QAM) scheme, and extracts MPEG-2 A/V TS from the demodulated data. After extracting, the QAM demodulator 320 outputs the MPEG-2 A/V TS to the multiplexer 330.

The cable MODEM 340 is a DOCSIS based cable MODEM, where DOCSIS denotes a data over cable service interface specifications. The cable MODEM 340 receives the data transmitted through the Out-of-band network from the tuner 310, and extracts MPEG-2 A/V transport stream (TS) and broadcasting supplementary data from the received data by demodulating the received data. The broadcasting supplementary data includes information about a conditional access and an electronic program guide (EPG). After extracting, the cable MODEM 430 transmits the MPEG-2 A/V TS to the multiplexer 330 in order to multiplex the MPEG-2 A/V TS with the data transmitted through the In-band network. The cable MODEM 430 also transmits the broadcasting supplementary data to the CPU 360 in order to process the broadcasting supplementary data according to a conventional DOCSIS Set-Top Gateway (DSG) standard. The cable MODEM 340 is a major element of the present embodiment. The cable MODEM 340 will be explained in detail with reference to related drawings in later.

The multiplexer 330 receives the MPEG-2 A/V TS from the QAM demodulator 320 and the cable MODEM 340, and multiplexes the received MPEG-2 A/V TS as single TS. After multiplexing, the multiplexer 330 outputs the multiplexed TS to an external cable card 250 through an In-band channel to process the multiplexed TS for the conditional access in the external cable card 250. The de-multiplexer 350 receives MPEG-2 A/V TS from the external cable card 250 through the In-band channel, and de-multiplexes the received MPEG-2 A/V TS.

The MPEG-2 A/V decoder 370 receives the de-multiplexed MPEG-2 A/V TS, and decodes the de-multiplexed MPEG-2 A/V TS. The decoded MPEG-2 A/V TS is outputted to a display unit to be reproduced.

The CPU 360 provides the broadcasting supplementary data outputted from the cable MODEM 340 to a CPU interface channel of the external cable card to process a conditional access, and generally controls the above described elements.

As described above, the apparatus for receiving MPEG-2 A/V data using the cable MODEM according to the present embodiment separates MPEG-2 A/V broadcasting data inputted through the cable MODEM 340 from other data, i.e., the broadcasting supplementary data, and multiplexes the separated MPEG-2 A/V data with MPEG-2 A/V broadcasting data inputted to the QAM demodulator 320 through the In-band Network. After multiplexing, the apparatus according to the present embodiment transmits the multiplexed MPEG-2 A/V broadcasting data to the cable card through an In-band channel of a card interface based on a conventional OpenCable standard, which guarantees a transmission rate of maximum 200 Mbps. Therefore, the apparatus for receiving MPEG-2 A/V data using a cable MODEM completely overcomes the conventional problems, i.e., data loss and delay, caused by transmitting MPEG-2 A/V broadcasting data from an OpenCable based set-top box to a cable card through an extended channel having a transmission rate of below 7 Mbps.

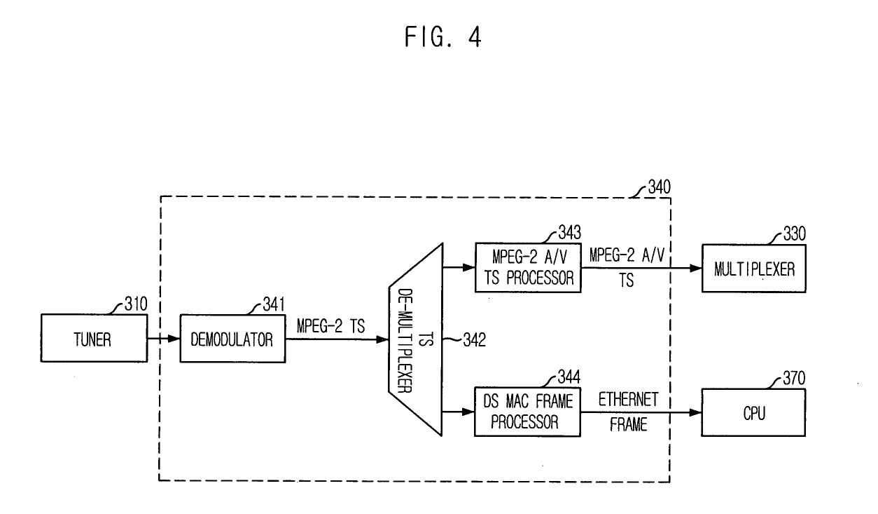

FIG. 4 is a detailed diagram illustrating a cable modem in accordance with a preferred embodiment of the present invention.

As shown in FIG. 4, the cable MODEM 340 according to the present embodiment includes a demodulator 341, a TS de-multiplexer 342, a MPEG-2 A/V TS processor 342 and a DS MAC frame processor 344.

The demodulator 340 receives the data from the tuner 210 and demodulates the received data to MPEG-2 TS. After demodulating, the demodulator 340 outputs the MPEG-2 TS to the TS de-multiplexer 342. The TS de-multiplexer 342 extracts TS of broadcasting program and MAC frame from the MPEG-2 TS. The extracted TS is processed in the MPEG-2 A/V TS processor 343, and transmitted to an In-band channel of the cable card through the multiplexer 330. The extracted MAC frame is processed in the DS MAC frame processor 344, and is transmitted to the CPU 370. Hereinafter, each element of the cable MODEM 340 will be explained in detail.

The TS de-multiplexer 342 checks a PID value of the inputted MPEG-2 TS from the demodulator 341. If the PID value is 0xFFE, corresponding data is determined as TS transmitting DOCSIS MAC data and outputted to the DS MAC frame processor 344. If the PID value of the inputted MPEG-2 TS is a value of A/V data of a program selected by a user, corresponding data is decided as a TS transmitting A/V data and transmitted to the MPEG-2 A/V TS processor 343. Processing MPEG-2 TS in the TS de-multiplexer 342 will be explained with reference to related drawing in later.

The MPEG-2 A/V TS processor 343 outputs the MPEG-2 A/V TS received from the TS de-multiplexer 404 to the multiplexer 330 through a TS FIFO (First In First Out) memory prepared in the MPEG-2 A/V TS processor 343.

The DS MAC frame processor 344 transmits data related to the IP service and the broadcasting supplementary data to the CPU 370. The broadcasting supplementary data is process by transmitting the supplementary data to the cable card through the extended channel as mentioned above.

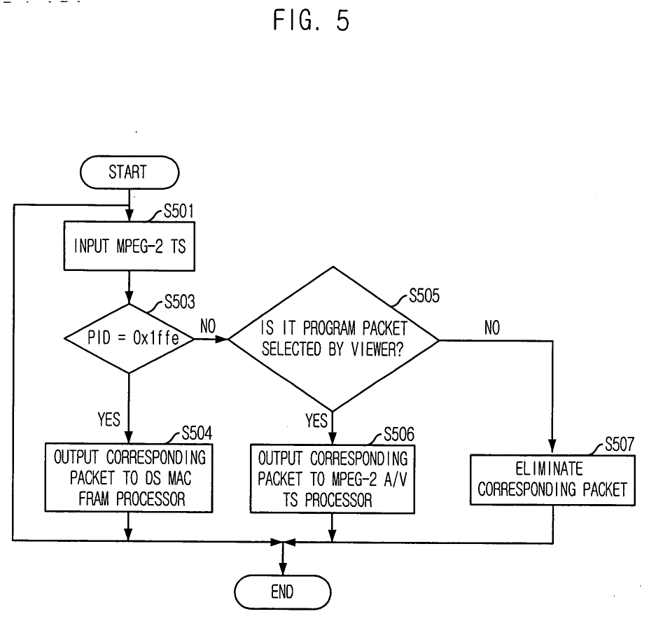

FIG. 5 is a flowchart of a method for processing MPEG-2 TS in a cable modem in accordance with a preferred embodiment of the present invention.

As shown in FIG. 5, the demodulator receives MPEG-2 TS at step S501. Then, a PID value of the received MPEG-2 TS is checked and determined whether the PID value is 0x1ffe or not at step S503.

If the PID value is 0x1ffe at step S503, corresponding packet is outputted to the DS MAC frame processor 344 at step S504.

If the PID value is not 0x1ffe at step S503, it determines whether the corresponding packet is a program packet selected by a viewer at step S505.

If the corresponding packet is the program packet selected by the viewer at step S505, the corresponding packet is outputted to the MPEG2 A/V TS processor at step S506, and if not, the corresponding packet is destroyed at step S507.

The above described invention can also be embodied as computer-readable code on a computer-readable recording medium including a CD-ROM, a RAM, a ROM, a floppy disk, a hard disk and a magneto-optical disk.

As described above, MPEG-2 A/V broadcasting data can be transmitted and processed through not only OpenCable based system, but also DOCSIS based cable MODEM while maintaining a physical interface defined in a conventional cable card according the present invention.

Also, broadcasting data conventionally provided through a QAM scheme based In-band network can be transmitted through DOCSIS based cable MODEM according to the present invention if a transmission speed of a DOCSIS based data transmitting/receiving network is advanced to faster than 100 Mbps.

Furthermore, the present invention completely overcomes the conventional problems, i.e., data loss and delay, caused by transmitting MPEG-2 A/V broadcasting data to a cable card through an extended channel having a transmission rate of below 7 Mbps, because the apparatus for receiving MPEG-2 A/V data using the cable MODEM according to the present invention separates MPEG-2 A/V broadcasting data inputted through the cable MODEM from the broadcasting receiving and supplementary data or IP communication related data, multiplexes the separated MPEG-2 A/V broadcasting data with MPEG-2 A/V broadcasting data inputted to the QAM demodulator through the In-band Network, and transmits the multiplexed MPEG-2 A/V broadcasting data to the cable card through an In-band channel guaranteeing a transmission rate of maximum 200 Mbps,

The present invention contains subject matter related to Korean patent application Nos. 2004-0105092 and 2005-038704, filed in the Korean patent office on Dec. 13, 2004, and May 10, 2005, respectively, the entire contents of which being incorporated herein by reference.

While the present invention has been described with respect to certain preferred embodiments, it will be apparent to those skilled in the art that various changes and modifications may be made without departing from the spirit and scope of the invention as defined in the following claims.

What is claimed is:

1. An apparatus for receiving broadcasting data using a cable MODEM in a digital cable broadcasting system, the apparatus comprising:
a cable MODEM for separating broadcasting data and broadcasting supplementary data by demodulating an input signal; and
a multiplexer for multiplexing the separated broadcasting data from the cable MODEM with broadcasting data inputted from other input source, and outputting the multiplexed broadcasting data to an external cable card.

2. The apparatus as recited in claim 1, wherein the multiplexer outputs data to the external cable card through an In-band channel.

3. The apparatus as recited in claim 2, further comprising:
a tuning means for receiving a radio frequency (RF) signal, and separating and outputting data transmitted through an In-band network and data transmitted through an Out-of-band network by tuning the received RF signal;
a QAM demodulating means for receiving the data transmitted through the In-band network from the tuning means, and extracting and outputting MPEG-2 A/V TS from the received data by demodulating broadcasting signal modulated based on a quadrature amplitude modulation (QAM) scheme;
a de-multiplexing means for receiving MPEG-2 A/V TS from the external cable card through an In-band channel, and de-multiplexing and outputting the received MPEG-2 A/V TS;
a MPEG-2 A/V decoding means for receiving the de-multiplexed MPEG-2 A/V TS from the de-multiplexing means, and decoding and outputting the de-multiplexed MPEG-2 A/V TS to be reproduced by a display device; and
a controlling means for receiving the broadcasting supplementary data outputted from the cable MODEM, and outputting the broadcasting supplementary data to the external cable card through a CPU interface channel in order to perform a operation for a conditional access.

4. A cable MODEM in a digital cable broadcasting receiving system for processing broadcasting data received through a cable MODEM according to a conditional access in a cable card, the cable MODEM comprising:
a demodulating means for demodulating an inputted signal; and
a data separating means for receiving the demodulated signal from the demodulating means and separating broadcasting data and broadcasting supplementary data from the demodulated signal.

5. The cable MODEM as recited in claim 4, wherein the data separating means uses a PID value of inputted data for separating broadcasting data and broadcasting supplementary data.

6. The cable MODEM as recited in claim 5, wherein the data separating means destroys the separated broadcasting data if the separated broadcasting data is not a program selected by a user.

7. The cable MODEM as recited in claim 5, further comprising:
a broadcasting data processor for receiving the broadcasting data from the data separating means, and outputting the broadcasting data to be transmitted through an In-band channel to an external cable card; and
a broadcasting supplementary data processor for receiving and outputting the broadcasting supplementary data from the data separating means.

8. The cable MODEM as recited in claim 5, wherein the broadcasting data is MPEG-2 A/V data.

9. The cable MODEM as recited in claim 5, wherein the broadcasting supplementary data includes conditional access data.
